(19) United States
(12) Patent Application Publication
(10) Pub. No.: US 2006/0192177 A1
(43) Pub. Date: Aug. 31, 2006

(54) Essentially thickness independent single layer photoelastic coating

(76) Inventors: Leishan Chen, Gainesville, FL (US); James Paul Hubner, Gainesville, FL (US); Yao Liu, Columbus, OH (US); Kirk S. Schanze, Gainesville, FL (US); Peter G. Ifju, Newberry, FL (US)

Correspondence Address: AKERMAN SENTERFITT, P.O. BOX 3188, WEST PALM BEACH, FL, 33402-3188, US

(21) Appl. No.: 11/067,409

(22) Filed: Feb. 25, 2005

(51) Int. Cl. C09K 11/02

(52) U.S. Cl. 252/301.35

(57) ABSTRACT

An essentially thickness independent luminescent photoelastic coating is a single layer having a photoelastic material, a polarizing preserving luminescent dye, and an excitation absorption dye therein. The absorption dye limits a penetration depth of excitation radiation incident on the layer. The thickness of the layer is greater than a penetration depth of the excitation radiation. A strain measurement system and associated method of determining strain utilize the single layer coating.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to the field of strain measurement, more particular, to single layer strain sensitive coatings which provide both photoelasticity and luminescence.

### BACKGROUND

Photoelastic coatings are used to determine surface stress and strain on mechanical components. Differing from traditional reflective based photoelastic coatings, the luminescent photoelastic coating (LPC) technique incorporates a luminescent dye either in an underlayer with a photoelastic overcoat (a dual-layer coating) or directly into the photoelastic coating itself (single-layer coating). The dye is formulated to retain polarization of the illuminating field. Benefits resulting from using luminescence rather than reflectance include increased viewing angles on complex objects due to the diffuse luminescent emission and elimination of specular reflection via optical filtering.

For example, advanced photoelastic-based testing tools have been developed to measure full-field strain information necessary to accelerate the Product LifeCycle Management (PLM) and to validate finite element analysis (FEA) models of complex 3D components, such as disclosed in U.S. application Ser. No. 10/407,602 filed on Apr. 4, 2003 entitled “METHOD AND APPARATUS FOR MEASURING STRAIN USING A LUMINESCENT PHOTOELASTIC COATING”. Application Ser. No. 10/407,602 discloses a method and apparatus for measuring strain on a surface of a substrate utilizes a substrate surface coated with at least one coating layer. The coating layer provides both luminescence and photoelasticity. The coating layer is illuminated with excitation light, wherein longer wavelength light is emitted having a polarization dependent upon stress or strain in the coating. At least one characteristic of the emitted light is measured, and strain (if present) on the substrate is determined from the measured characteristic. Application Ser. No. 10/407,602 was published as Published Patent Application 20040066503 on Apr. 8, 2004 and is incorporated herein by reference in its entirety.

A schematic of instrumentation for the determination of strain using a strain sensitive coating based on application Ser. No. 10/407,602 is shown in FIG. 1. When excited with polarized excitation radiation from a suitable excitation source 110 (e.g. one or more LEDs or laser diodes) together with a polarizer 114 and quarter wave plate 117, for example for generating circularly polarized blue light, the corresponding emission intensity from the coating 120 is measured over a sequence of analyzer (polarizing optic) angles using a digital camera 130. The relative change in emission magnitude and phase are related to the in-plane shear strain and its corresponding principal direction in the specimen 135. The technique offers visual, quantitative, repeatable, and high spatial resolution measurements.

The component of interest (e.g. metallic or composite) is generally sprayed using conventional aerosol equipment, cured overnight, and tested (either static or cyclic loading) the following day. Achieving uniform coating thickness is known to be difficult, especially with the preferred spray application. If uncorrected, thickness variation can significantly change measured results and introduce a high level of measurement error. As a result, data post-processing methodology is generally used to correct for thickness dependence when accurate quantitative measurements are required.

For example, one exemplary thickness correction method is a ratiometric method which utilizes the variation of the coating's fluorescence as a function of coating thickness for a plurality of wavelengths, wherein the coating exhibits a fluorescence intensity that varies independently as a function of coating thickness at two or more different fluorescence wavelengths. Such a correction clearly adds complexity and time to both the coating as well as the strain measurement process.

### SUMMARY

A thickness independent luminescent photoelastic coating is a single layer having a photoelastic material, a polarizing preserving luminescent dye, and an excitation absorption dye therein. The absorption dye limits a penetration depth of excitation radiation incident on the layer. The thickness of the layer is greater than a penetration depth of the excitation radiation. The photoelastic material is preferably a polymer, the polymer comprising at least 20 wt. % of the coating layer. The coating provides a strain-optic sensitivity coefficient of at least 0.001, and is preferably from 0.01 to 0.2.

The weight percentage of the absorption dye is between 0.01% to 5%, and is preferably between 0.1% and 1.0 wt. %. In a preferred embodiment, an absorption peak of the absorption dye is spaced apart from an emission peak of the luminescent dye by at least 50 nm.

A method for measuring strain comprising the steps of providing a substrate surface coated with a single layer, the single layer including a photoelastic material, a polarizing preserving luminescent dye, and an excitation absorption dye, where the absorption dye limits a penetration depth of excitation radiation incident on the layer. The thickness of the single layer is greater than a penetration depth of the excitation radiation. The single layer coating is lluminated with polarized excitation radiation, wherein longer wavelength luminescent light is emitted having a polarization state dependent upon stress or strain in the coating layer. The polarization state of the luminescent light is measured and the strain on the substrate surface is determined from the polarization state data. The polarized excitation radiation can comprise circularly polarized light. The polarization state of the luminescent light can include the direction of maximum principal strain on the substrate surface. An apparatus for measuring strain using coatings according to the invention measures the polarization state of the luminescent light and determines the strain on the substrate from the polarization state data.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 shows a schematic of a basic luminescent photoelastic coating (LPC) instrument for obtaining shear strain measurements.

FIG. 2 shows a schematic of penetration depth of excitation due to the absorption dye within a single layer LPC according to the invention showing the absorption dye limiting the penetration depth of the excitation radiation.

FIG. 3 shows an exemplary absorbance spectrum of a single layer LPC according to the invention including an absorption dye and luminescent dye which provide absorption in different regions of the spectrum.

FIG. 4 shows the theoretical OSR for various LPC coating thicknesses according to the invention: h*=0.40 μm and a=0.0056 μm⁻¹. This corresponds to a 99% penetration depth at 360 μm.

FIG. 5 shows theoretical strain difference relative to a 360 μm coating according to the invention (h*=0.40 μm, a=0.0056 μm⁻¹).

FIG. 6 shows the normalized intensity respect to the CCD full-well capacity for two (0.0% and 0.5% Ru-based dye) LPC coated aluminum specimens with stepwise varying thickness according to the invention.

FIG. 7 shows the OSR for three (0.0%, 0.25% and 0.5% Ru-based absorption dye) LPC coated aluminum specimens according to the invention with stepwise varying thickness.

FIGS. 8(a) and 8(b) are scanned images indicating the maximum shear strain and principal direction distribution for an aluminum open-hole specimen having a coating according to the invention disposed thereon.

FIG. 9 provides shear strain results from a comparison test on an anisotropic material having a coating according to the invention disposed thereon.

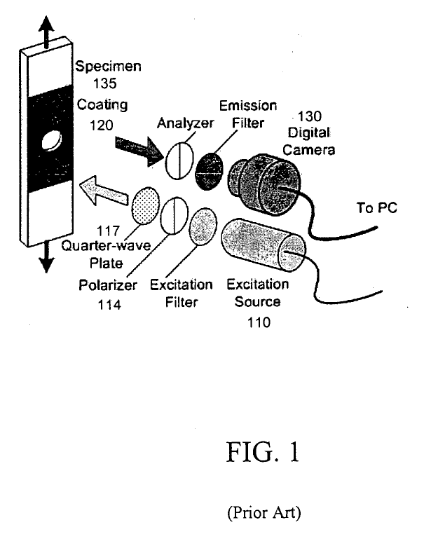

### DETAILED DESCRIPTION

A single-layer essentially thickness independent luminescent photoelastic coating (LPC) includes a polarizing maintaining luminescent dye and an excitation absorption dye. Although a single luminescent and a single absorption dye is generally utilized with the invention, two or more luminescent and/or absorption dyes may be used. Coatings according to the invention can be used to measure the full-field shear strain distribution and orientation. The inventive coating overcomes, or at least sharply reduces, thickness and adhesion related deficiencies in dual-layer strain sensitive coatings previously utilized.

As defined herein, a “polarizing maintaining luminescent dye” is a dye that allows the coating to provide a luminescent signal responsive to a polarized optical excitation signal, where at least 5% of the luminescent signal intensity maintains the polarization of the excitation signal. Preferably, the coatings are at least 20% to 30% efficient in preserving polarization since the minimum strain resolution decreases with increasing polarization efficiency. An “absorption dye” is defined herein as a dye which absorbs the excitation signal, but does not emit significant electromagnetic radiation responsive to the excitation signal, such as dyes having a quantum yield of less than about 0.01%. The absorption dye thus acts as an attenuator to limit the depth by which the excitation radiation can penetrate into the coating. By adjustment of the concentration of the absorption dye, the excitation penetration depth can be set.

When the coating thickness that is greater than the penetration depth of the radiation is used, it has been found that the coating becomes essentially thickness independent. As used herein, the phrase “penetration depth” corresponds to a coating thickness sufficient to provide at least a 90% attenuation, preferably 99% attenuation, and most preferably 99.9% attenuation of the excitation signal intensity.

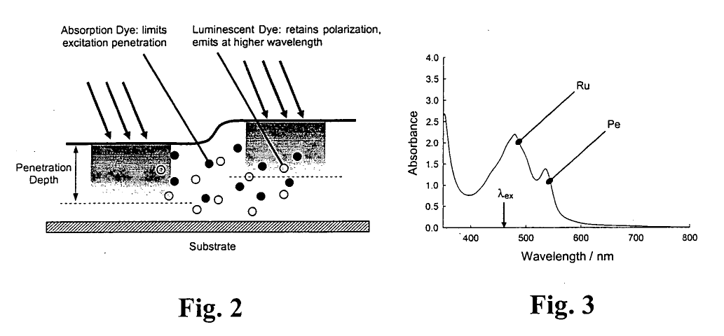

FIG. 2 is a schematic depiction regarding operation of an essentially thickness independent coating according to the invention. The absorption dye molecules limit the penetration depth of the excitation radiation. The luminescent dye retains the polarization of the excitation radiation and emits a red shifted luminescent signal.

The absorption dye preferably provides absorption in a band distinct from the luminescent signal emitted by the luminescent dye. This limits attenuation of the luminescent signal by the absorption dye which can undesirably reduce the luminescent signal level emitted from the coating. As used herein, “band distinct” corresponds to a spacing of the absorption and luminescent peaks of at least 25 nm, preferably at least 50 nm, and most preferably, at least 100 nm. The absorption dye is also preferably soluble in the non-polar solvents generally used to deliver the coating, which is desirable when wet processes such as spraying is used to deliver the coating. Suitable absorption dye choices can include, for example, ruthenium-based absorption dyes, such as bis(2,2′:6′,2″-terpyridine) ruthenium chloride.

In one exemplary configuration, bis(2,2′:6′,2″-terpyridine) ruthenium chloride (a absorption dye) and a perylene-based (Pe) luminescent dye, such as N,N′-bis(2,5-di-tert-butylphenyl)-3,4,9,10 perylenedicarboximide, are incorporated into an epoxy-based photoelastic overcoat. FIG. 3 shows the absorption spectrum of the coating, with the Ru-based dye providing the coating with strong absorption in the blue wavelengths near the wavelength of the excitation radiation λₑₓ to limit penetration depth of λₑₓ, but allowing the transmission in the red wavelengths where the luminescent dye emits to maximize signal intensity.

The excitation radiation is generally referred to as being “light”. As used herein, the term “light” refers to electromagnetic radiation having wavelengths both within the visible spectrum and outside the visible spectrum. For example, the invention can generally be practiced with visible, infrared and/or ultraviolet light provided appropriate luminophores and detectors are provided. Typical coating thickness is about 200 to 400 μm, but can be thicker or thinner than this typical range of thicknesses.

As noted above, the luminescent dye is preferably polarizing preserving. Examples of visible light luminescent polarizing preserving dyes are cyanine, rhodamine, coumarin, stilbene, perylene, rubrene, perylene diimide, phenylene ethynylene, and phenylene vinylene.

The photoelastic polymer binder preferably comprises at least 20 wt. % of the coating layer, such as 30%, 40% 50%, 60 or 70% of the coating layer. The polymer binder provides photoelasticity and is preferably substantially optically transparent to the wavelength of excitation radiation used for measuring strain. Examples of suitable polymer binders include, but are not limited to, epoxies, polyurethane, polyacrylate, cellulose acetate and poly(dimethylsiloxane). A variety of other optically transparent photoelastic materials can be used with the invention, such as polycarbonate or polymethylmethacrylate. Preferred materials are optically transparent in the wavelength range of interest, provide high polarization sensitivity, provide high optical sensitivity, have low surface roughness, have low viscosity or alterable viscosity with additives, have good adhesion qualities, and have reasonable curing times and conditions.

The strain-optic sensitivity of the coating is represented by the strain-optic sensitivity constant K which defines a fundamental property of the photoelastic material itself, and is independent of the coating thickness or the length of the light path. In order to translate measured intensity data fringe orders in a photoelastic coating into strains or stresses in the coated test object, it is necessary to introduce the strain-optic sensitivity constant of the coating. The strain-optic sensitivity constant K is dimensionless and for typical photoelastic polymers used in the stress or strain analysis of structural materials, varies from 0.05 to about 0.15, with the larger coefficients corresponding to the more optically sensitive materials.

Although a larger strain-optic sensitivity constant K is generally preferred, the invention generally only requires a coating which provides a strain-optic sensitivity constant of at least 0.001, which is primarily provided by the photolelastic polymer binder. There is also a curing epoxy generally added which may have photoelastic properties, but the photolelastic polymer binder component is generally at least ten times greater. For example, the strain-optic coefficient of the coating is generally between about 0.75 and 0.125 when the BGM polymer is photolelastic polymer binder, the actual value depends on the specific coating mixture used.

The structure for the BGM monomer is shown below as Structure 1.

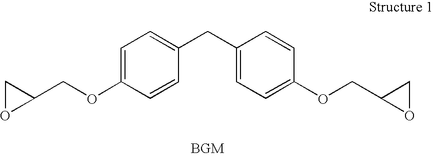

The BGM monomer has the following specifications:

| | | |
|---|---|---|
| Formula weight: | 312.37 | g-mol⁻¹, mp. −15° C. |
| Density: | 1.19 | g-mL |
| Viscosity (25° C.) | 2000-3000 | cps. |

Another exemplary photoelastic polymer material which can be used with the invention is formed from the curing of the bisphenol-A glycerolate diacrylate monomer. The structure for this monomer is shown in Structure 2. This monomer is quite viscous and can be cured by typical acrylate initiators. This epoxy monomer is an acrylate ester and generally shares properties with other acrylate coatings. Use of this epoxy monomer can produce an easily applied acrylate coating which has reduced flow after air brush deposition. The structure for the bisphenol-A glycerolate diacrylate monomer is shown below as Structure 2.

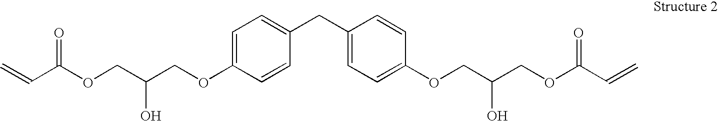

In one embodiment, a specific photoelastic coating formulation can include bisphenol-A glycerolate diacrylate (40-60%), chloroform (20-30%), toluene (10-20%) and benzoin ethyl ether (1-8%), where all values are listed in % by weight. The epoxy coating can be applied to the luminescent undercoat and cured by exposure to UV light for about 1 hour at ambient temperature.

Although not required to practice the invention, the inventors, not seeking to be bound by theoretical aspects regarding the invention, provide the following. For a conventional dual layer coating where luminescent molecules are dispersed in a separate layer underneath a top photoelastic layer, the governing equations are:

$$\begin{matrix}\frac{I}{{I}_{avg}} = 1 + ϕ sin ( Δ ) sin ( 2 α - 2 θ ) , \\ where & ( 1 ) \\ Δ = \frac{2 π Kh γ}{{λ}^{*}} & ( 2 ) \\ {λ}^{*} = \frac{{λ}_{ex} {λ}_{em}}{{λ}_{ex} + {λ}_{em}} & ( 3 )\end{matrix}$$

However, for single layer LPC coatings according to the invention, the governing equations are different because the luminescent molecules are dispersed throughout the photoelastic layer as opposed to in a layer underneath the photoelastic layer. Thus, both the relative luminescence and the retardation become thickness dependent. The relative intensity of excitation, Iₑₓ, at a given depth, y, is modeled using Beer's Law as shown in Eq. 4 below:
Iₑₓ(y)=I_{ex,o}e^{-ay} (4)
where a is the absorbitivity. Equation 5 models the effect the excitation attenuation has on the measured intensity response at a specific depth:

$$\frac{I ( y )}{{I}_{avg}} = {e}^{- ay} ( 1 + ϕ sin ( 2 π \frac{Ky γ}{{λ}^{*}} ) sin ( 2 α - 2 θ ) ) . \qquad ( 5 )$$

where the relative retardation, Δ, also depends on the thickness. Integrated over a depth h, the result is:

$$\frac{I}{{I}_{avg}} = \frac{1 - {e}^{- ah}}{a} + ϕ ( \frac{\frac{{h}^{*}}{γ} - {e}^{- ah} \frac{{h}^{*}}{γ} ( cos \frac{γ h}{{h}^{*}} + \frac{{ah}^{*}}{γ} sin \frac{γ h}{{h}^{*}} )}{1 + {( \frac{{ah}^{*}}{γ} )}^{2}} ) sin ( 2 α - 2 θ ) . \qquad ( 6 )$$

where h*, termed the photoelastic depth, is:

$${h}^{*} = \frac{{λ}^{*}}{2 π K} . \qquad ( 7 )$$

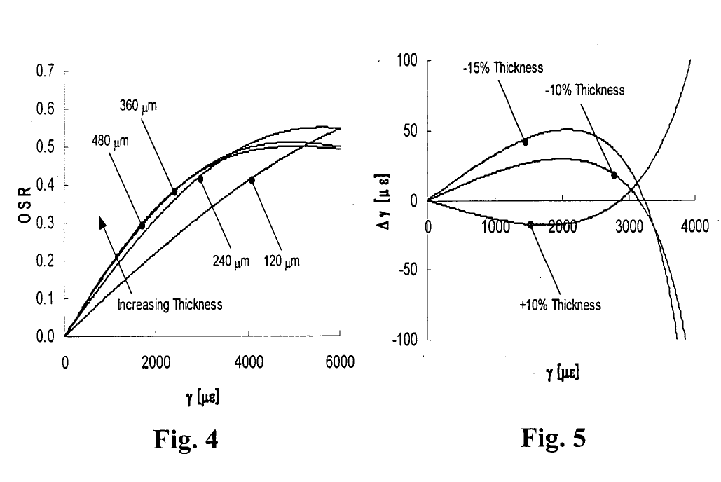

Because both the luminescent and absorption dye are distributed throughout the coating, the OSR of the single-layer coating is different compared to the theoretical sin(Δ) response of the dual-layer coating. FIG. 4 is a plot of the OSR with respect to strain as governed by Eq. 6 (h*=0.40 μm, a=0.0056 μm⁻¹). For a set thickness, the OSR increases with strain, then peaks and decreases, resulting in a multi-valued strain function. As the coating thickness is increased, the initial region of the OSR curves of FIG. 4 converge onto each other, indicating a penetration depth or threshold thickness in which the theoretical OSR is essentially independent of thickness. FIG. 5 shows the theoretical difference in strain (or strain error) resulting from thickness variations for a coating with a 99% absorption depth of 360 μm.

Equation 6 is simplified when h approaches a penetration depth such that e^{-ah} approaches zero:

$$\frac{I}{{I}_{avg}^{*}} = 1 + ϕ ( \frac{\frac{γ}{η}}{1 + {( \frac{γ}{η} )}^{2}} ) sin ( 2 α - 2 θ ) , \qquad ( 8 )$$

The nondimensional parameter η is a coating characteristic relating the absorptivity per unit depth to the photoelastic depth,

$$η = {ah}^{*} = a \frac{{λ}^{*}}{2 π k} \qquad ( 9 )$$

and I*_{avg} is the averaged intensity over 180° analyzer angle. For the case of an optically thick coating, the peak OSR of 0.5 occurs when η=γ. In terms of OSR (represented by δ in Eq. 10), the shear strain in the subfringe region is:

$$γ = \frac{η - η \sqrt{1 - 4 {( δ / ϕ )}^{2}}}{2 ( δ / ϕ )} . \qquad ( 10 )$$

Advantages of coatings according to the invention compared to traditional photoelastic techniques using thicker coatings and surface contouring may include:
1. more uniform emission signal at oblique viewing angles,
2. higher spatial resolution, especially near edges,
3. simpler post-processing by eliminating phase unwrapping and fringe counting,
4. less substrate reinforcement, and
5. lower coating residual strains.

The invention is expected to have a variety of applications. Coatings according to the invention can be used on virtually all solid materials, including, but not limited to, metallic, ceramic, plastic and composite specimens.

### EXAMPLES

The present invention is further illustrated by the following specific Examples, which should not be construed as limiting the scope or content of the invention in any way.

To test the single-layer concept, aluminum bar specimens—both primed black and unprimed—were sprayed-coated with varying concentrations of the absorption dye within the LPC, ranging from 0% to 0.5% Ru-based absorption dye by weight. The specimen dimensions were 38.1×3.18×304.8 mm. For each individual specimen, the LPC was sprayed in a manner to create four stepwise regions of increasing thickness from below 100 μm to above 300 μm. The thickness was measured using a contact eddy-current probe. Two sample tests were conducted.

The first test was an intensity test to demonstrate the effect of the absorption dye on the overall measured luminescent intensity with respect to coating thickness. The second test was a tensile test in which the specimens were subjected to a maximum tensile load 16.7 kN, and the OSR was measured. For each test, a blue LED lamp (465 nm center wavelength) was used to excite the coating. The luminescence was measured, in a darkened environment, with a 16-bit digital charged-couple device (CCD) camera fitted with a bandpass interference filter (550 nm center wavelength) and an f-mount zoom lens. For the OSR tests, wavelength-matched polarization and retardation optics were fitted with the blue LED lamp to create circular polarized light, and an analyzing optic was placed in front of the CCD emission filter. The optical sensitivity of the coating is ˜0.1. At any given load state, including an unloaded state, a sequence of four images were acquired at 45° analyzer angle intervals. The images for the unloaded state were used to correct the unloaded signal offset due to residual strains in the coating or unpolarized luminescent reflections. A full description of the general LPC analysis process is described in Hubner, J. P., Ifju, P. G., Schanze, K. S., Liu, Y., Chen, L., and El-Ratal, W., “Luminescent Photoelastic Coatings,” Proceedings of the 2003 SEM Annual Conference and Exposition, Paper #263, June 2003.

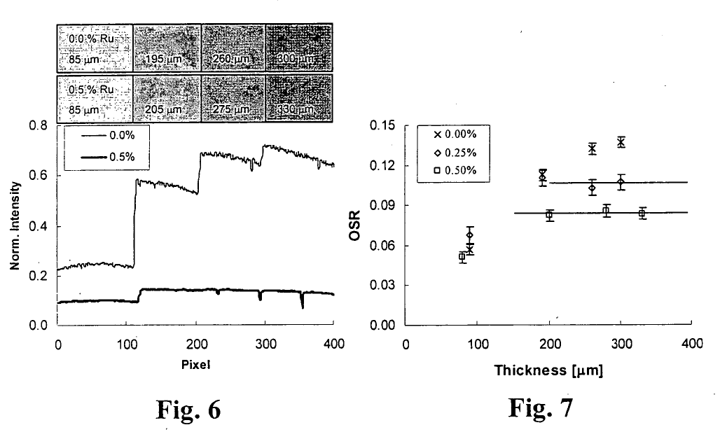

FIG. 6 shows the effect of the absorption dye on the measured luminescent intensity from the coating. Plotted is the centerline intensity, normalized relative to the CCD full-well capacity, for two black-primed specimens. The thickness of the coating for both specimens increases from left to right as shown. For the 0.0% Ru-based adsorption dye specimen, the normalized intensity relative to the CCD full-well capacity increases with increasing coating thickness as indicated by the three distinct steps between the four regions. The gradual roll-off in intensity along a specific region is due to the spatially varying excitation field. The relative change in the intensity for each step is nearly proportional to the relative change in thickness, showing little absorption of the excitation by the luminescent dye or photoelastic coating. Contrastingly, the normalized intensity for the 0.5% Ru-based absorption dye specimen is relatively constant across the third and fourth regions with a slight drop in the second region. The only clear step in the data is between 85 and 205 μm, indicating that the coating is near optically thick at greater thicknesses. The absorptivity of the 0.5% Ru-based absorption dye LPC is 0.0074 μm⁻¹. This corresponds to a transmission ratio, T, of 3% or an absorbance, A, of 1.5 at 205 μm. Not clearly visible in FIG. 6 is the spatial roll-off of intensity for the 0.5% Ru-based absorption dye concentration, which is the same relative amount as the 0.0% Ru-based absorption dye case. Unprimed specimens displayed similar thickness independent characteristics, but the working threshold thickness was greater due to the luminescent reflection off the metallic surface.

The consequence of creating an optically thick coating is lower detected emission and thus increased exposure times to use the full dynamic range of the CCD camera. LPC exposure times range between 5 to 90 s depending on coating absorptivity, coating thickness, LED placement and power, CCD placement and sensitivity, and lens selection. The following techniques were found to increase the signal-to-noise characteristics of the measurement:
1. increasing the exposure time,
2. increasing the number of analyzer angles,
3. increasing the number of images acquired per load and analyzer image, and
4. increasing spatial pixel averaging, at the expense of spatial resolution.

FIG. 7 shows the OSR (the amplitude of Eq. 8) with respect to thickness for three specimens (0.0%, 0.25%, and 0.5% Ru-based absorption dye). The applied shear strain (via tensile loading) was 2600 με. Clearly, OSR for the specimen without the absorption dye is thickness dependent. For the other two specimens, increasing the Ru-based absorption dye concentration decreases the OSR. However, OSR is thickness independent (within the noise bounds) once a threshold thickness is achieved. The working threshold thickness of the LPC is roughly 250 and 200 μm for the 0.25% and 0.5% specimens, respectively, which is lower than the 99% absorption level. The error bars indicate a 2σ deviation (95% confidence) of the sample pixel population. The OSR at 2600 με for the 0.0% (300 μm), 0.25% and 0.5% specimens were 0.127, 0.106 and 0.084, respectively. Thus, increasing the absorption dye concentration decreases the optical strain response. This is also expected as shown in Eqs. 8 and 9. If the absorption dye is increased, the absorptivity, a, increases which in turn increases the nondimensional parameter, 72.

A significant finding of the OSR measurements is that the strain-dependent response of the single-layer coating is effectively thickness independent once a threshold thickness is achieved. Advantages of the single-layer coating include:
1. thickness independent strain response for optically thick coatings (target absorbance of ˜1.7 (about 98% absorbance),
2. increase in the maximum subfringe strain level due to the distribution of the luminescent dye throughout the coating instead of underneath the coating,
3. elimination of compliance and adhesion issues due to improper application/cure or modulus mismatch between multiple layer coatings,
4. and easier coating preparation and application.

### EXEMPLARY APPLICATIONS

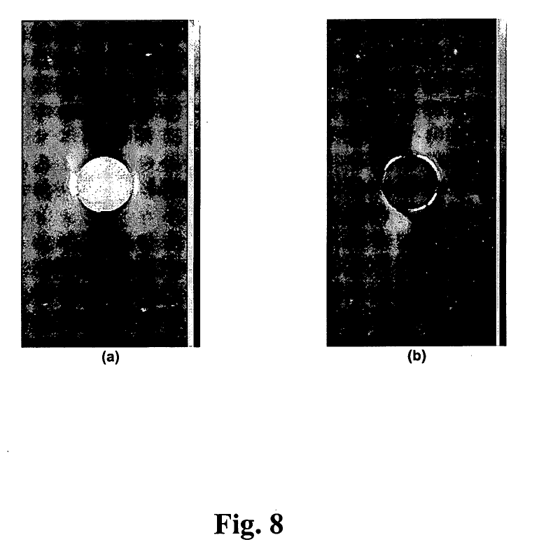

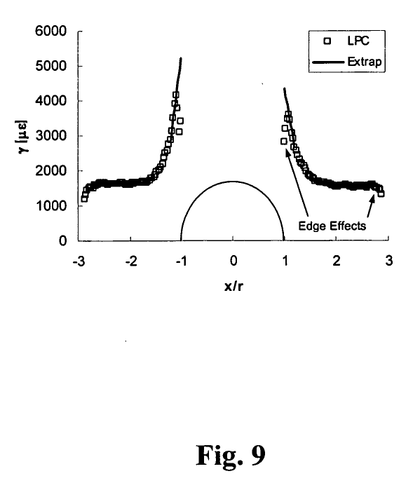

FIGS. 8(a) and (b), and FIG. 9 show results from a single layer coating tested on specimens with non-uniform strain fields. FIGS. 8(a) and 8(b) are scanned images indicating the maximum shear strain and principal direction distribution for an aluminum isotropic open-hole tension specimen. The 2024-T6 aluminum specimen was 6.4 mm thick and 38.1 mm wide. The ratio of the hole diameter to specimen width was 1:3. A tensile load of 19.2 kN was applied in the vertical direction. For FIG. 8(a), white and light-gray regions (up to 5000 microstrain) near the left and right of the hole indicate high strain areas, and black and dark-gray regions above and below the hole indicate low strain areas. For FIG. 8(b), white, gray and black correspond to +30, 0 and −30 degrees, respectively (0 degrees is vertical). Clearly present are the stress concentrations on both sides of the hole as well as regions of shielded stress above and below the hole. High stress regions radiate out as lobes along diagonal axes as expected.

FIG. 9 provides shear strain results from a comparison test on an anisotropic material. The unidirectional composite specimen was made of AS4/3501-6 (24 plies). The ratio of hole diameter to specimen width was 1:4; the maximum load was 4.5 kN. Instead of the shear strain contours radiating from the hole at approximately 45°, the high stress regions radiate out in the vertical directions from the sides of the hole. Additionally, the maximum shear strain is not along the horizontal axis passing through the center of the hole, but rather, located just above and below this axis. This is due to the compliant shear planes associated with the unidirectional laminate. The maximum shear strain is approximately four times higher than the average shear strain across the axis of minimum area.

This invention can be embodied in other forms without departing from the spirit or essential attributes thereof and, accordingly, reference should be had to the following claims rather than the foregoing specification as indicating the scope of the invention.

We claim:

1. A thickness independent luminescent photoelastic coating, comprising:
a single layer including a photoelastic material, a polarizing preserving luminescent dye, and an excitation absorption dye, said absorption dye limiting a penetration depth of excitation radiation incident on said layer, wherein a thickness of said layer is greater than a penetration depth of said excitation radiation.

2. The coating of claim 1, wherein said photoelastic material is a polymer, said polymer comprising at least 20 wt. % of said coating layer, said coating providing a strain-optic sensitivity constant of at least 0.001.

3. The coating of claim 2, wherein said strain-optic sensitivity constant is from 0.01 to 0.2.

4. The coating of claim 1, wherein a weight percentage of said absorption dye is between 0.01% and 5.0%.

5. The coating of claim 1, wherein an absorption peak of said absorption dye is spaced apart from an emission peak of said luminescent dye by at least 50 nm.

6. A method for measuring strain, comprising the steps of:
providing a substrate surface coated with a single layer, said single layer including a photoelastic material, a polarizing preserving luminescent dye, and an excitation absorption dye, said absorption dye limiting a penetration depth of excitation radiation incident on said layer, wherein a thickness of said layer is greater than a penetration depth of said excitation radiation;
illuminating said single layer with polarized excitation radiation, wherein longer wavelength luminescent light is emitted having a polarization state dependent upon stress or strain in said layer;
measuring said polarization state of said luminescent light, and
determining strain on said substrate surface from said polarization state.

7. The method of claim 6, wherein said photoelastic material is a polymer, said polymer comprising at least 20 wt. % of said coating layer, said coating providing a strain-optic sensitivity of at least 0.001.

8. The method of claim 6, wherein said polarized excitation radiation comprises circularly polarized light.

9. The method of claim 6, wherein an absorption peak of said absorption dye is spaced apart from an emission peak of said luminescent dye by at least 50 nm.

10. The method of claim 6, wherein said polarization state includes the direction of maximum principal strain on said substrate surface.

11. An apparatus for measuring strain, comprising:
an excitation light source and optics for generating polarized excitation light to illuminate a surface of a substrate, said substrate including a single layer coating, said single layer including a photoelastic material, a polarizing preserving luminescent dye, and an excitation absorption dye, said absorption dye limiting a penetration depth of excitation radiation incident on said layer, wherein a thickness of said layer is greater than a penetration depth of said excitation radiation;
a detector for measuring luminescent light emitted by said coating responsive to said excitation light, said emitted light being at a longer wavelength and having a polarization modified as compared to said polarized excitation light based upon stress or strain on said coating, and
a computer for processing to determine strain on said substrate surface from said emitted light.

12. The apparatus of claim 11, wherein said polarized excitation light comprises elliptically polarized light.

13. The apparatus of claim 11, wherein said photoelastic material is a polymer, said polymer comprising at least 20 wt. % of said coating layer, said coating providing a strain-optic sensitivity constant of at least 0.001.
